(19) United States
(12) Patent Application Publication
(10) Pub. No.: US 2023/0093768 A1
(43) Pub. Date: Mar. 23, 2023

(54) PACKAGING FOR FRUIT AND VEGETABLES WITH ANTIPATHOGEN BARRIER AND PRODUCTION METHOD

(71) Applicant: Sergio Fernando GRIJALVA VARILLAS, Zapopan (MX)

(72) Inventor: Sergio Fernando GRIJALVA VARILLAS, Zapopan (MX)

(21) Appl. No.: 17/994,513

(22) Filed: Nov. 28, 2022

Related U.S. Application Data
(63) Continuation of application No. PCT/MX2021/050013, filed on Mar. 11, 2021.

(51) Int. Cl. B65D 81/24; B65D 65/42

(52) U.S. Cl. CPC B65D 81/24; B65D 65/42; B65D 2203/00

(57) ABSTRACT

The presence of pathogens in fresh food is the cause of food loss and the spread of diseases and death in humans. Packaging disclosed herein includes a semi-rigid or flexible package for fresh fruits and vegetables, which incorporates an antipathogenic barrier using carbon allotrope ink and air filters. An embodiment of a packaging container is formed of a body and a paperboard lid, the body having a geometric pattern printed in its interior with antipathogenic ink. The container body includes a bottom with a hollow window, covered by two or more layers of microperforated polymeric films that have an air filtration function. A version of a semi-rigid cellulose lid incorporates a hollow window, covered by two or more microperforated polymeric films. Further disclosed is a portion of the container made of cellulose material and printed with antipathogenic ink.

### CROSS REFERENCE TO RELATED APPLICATION

This application is a bypass continuation that claims priority to International Patent Application No. PCT/MX2021/050013 filed on Mar. 11, 2021, where the entire content of the foregoing is incorporated herein by reference.

### TECHNICAL FIELD

The present invention pertains generally to packaging for fresh fruits and vegetables, and more particularly to packaging including with an antipathogenic barrier and manufacturing processes therefor.

### BACKGROUND OF THE INVENTION

In a study conducted by the UN WHO (World Health Organization) in the year 2020, it was estimated that 600 million—nearly 1 in every 10 people in the world—get sick from eating contaminated foods and 420,000 of these people die every year. Food-borne illnesses are usually infectious or toxic in nature, and are caused by bacteria, parasites, or chemical substances that enter the body through contaminated food or water. Food-borne pathogens can cause serious diarrhea or debilitating infections, including meningitis.

Furthermore, Johns Hopkins University of Medicine—Coronavirus Resource Center estimates that, as of March 2021, the SARS-CoV-2 pandemic has had as a result more than 2.6 million people killed and another 115 million people infected by the virus. According to an official statement from the WHO, the SARS-CoV-2 virus can remain active for up to 72 hours on plastic and stainless-steel surfaces, up to 4 hours on copper surfaces, and up to 24 hours on paper surfaces. The recent pandemic invites us to reconsider packaging systems such that they guarantee proper hygiene and the capacity to keep foods packaged with an appropriate prophylaxis, avoiding external contamination. Bacteria, viruses, and fungi are also responsible for the degradation of fresh food. In a study by the FAO (Worldwide Food and Agriculture Organization), 45% of fresh fruits and vegetables, as well as 45% of roots and tubers are lost or wasted. According to the FAO, there are three factors in these losses: inadequate logistics, packaging that does not meet the needs, and the end consumer who does not consume or safely store the fruits and vegetables. Within these three factors found by the FAO, specifically related to packaging and the end consumer, dehydration and the presence of bacteria are notable as the principal elements in the loss of fresh foods. Fresh fruit and vegetable packaging solutions existing in the market do not have barriers for filtering and air control within the packaging, and they are often manufactured with nonrenewable materials such as PET, PP, and PS. Existing packaging manufacturing techniques use industrial processes such as thermoforming and plastic injection. These packaging solutions have perforations or ventilation windows which either (i) let too much air in, thereby accelerating the dehydration of the packaged fruit or vegetable, or (ii) the ventilation is not sufficient, thereby helping pathogens proliferate.

### BRIEF SUMMARY OF THE EMBODIMENTS

Embodiments disclosed herein are directed to packaging with an antipathogenic (bacteria, virus, and/or fungus) barrier for fresh fruits and vegetables. The packaging may be manufactured with semi-rigid, cellulose-based, and/or rigid and flexible polymers, which permit the reduction and/or elimination of pathogens present in the air and/or on the surface of produce, preventing the development of pathogens inside the packaging. The packaging includes a carbon allotrope-based ink (antibacterial or antipathogenic ink) on its inside, as well as on the bottom and the lid. The ink has geometric and nanometric chemical properties, which destroy pathogens.

The packaging and manufacturing methods therefor presented herein propose to resolve the cited problems; by using renewable, rigid cellulose-based and/or flexible polymeric materials, such as PLA polylactic acid, as well as the use of two or more microperforated layers treated on the surface with special carbon allotrope-based nanotechnology inks, which destroy external adverse micro agents when these come into contact with the surface-treated packaging surfaces. Furthermore, a manufacturing process is proposed for those areas functioning as air filters, based on two or more microperforated polymeric layers, or one layer of perforated rigid cellulose, treated with carbon allotrope-based ink with nanometric geometry. These layers are not laminated, but joined only in specific areas, allowing airflow in a tortuous manner between the layer and the microperforated layer, filtering the air in its course and leaving on these layers adverse micro agents adhered to the surface that will later be destroyed by the antipathogenic characteristics specific to the ink.

According to one or more embodiments, a package for fruits and vegetables has an antipathogenic barrier, the package comprising:

a container formed from a strip of semi-rigid material folded onto itself, the container having one or more internal walls;

a geometric pattern comprising a carbon allotrope-based ink printed on at least one of the one or more internal walls; and

wherein the geometric pattern includes lines printed with a line density based upon a predetermined grade of antipathogenic barrier.

According to one or more embodiments, the container includes a bottom having a hollow window; the hollow window is covered by a membrane including two or more films of microperforated polymeric material; and the geometric pattern comprising a carbon allotrope-based ink is printed on the two or more films such that the membrane provides an antipathogenic barrier.

According to one or more embodiments, the container includes a bottom formed of a cellulosic material having a plurality of perforations substantially homogeneously distributed on a surface of the bottom. The geometric pattern comprising a carbon allotrope-based ink is printed on the two or more films such that the membrane provides an antipathogenic barrier.

According to one or more embodiments, a lid is structurally configured to cover the container, the lid having a hollow window covered by a membrane including two or more films of microperforated polymeric material. The geometric pattern comprises a carbon allotrope-based ink printed on the two or more films such that the membrane provides an antipathogenic barrier. In some embodiments, the lid is formed of at least one of a semi-rigid cellulose material and a rigid polymeric material.

According to one or more embodiments, the geometric pattern is printed via one of flexography, rotogravure, and sublimation printing processes.

According to one or more embodiments, a package for fruits and vegetables has an antipathogenic barrier, the package comprising:

a bag having a laminated body including two or more layers of flexible polymeric material and one or more internal walls;

a geometric pattern comprising a carbon allotrope-based ink printed on at least one of the one or more internal walls;

at least a portion of the bag including two or more microperforated polymeric film layers including the geometric pattern printed thereon; and

wherein the two or more microperforated polymeric film layers are attached to one another only along one or more edges thereof.

According to one or more embodiments, a finish for a surface has antipathogenic properties, the finish comprising:

a carbon allotrope-based ink having a nanometric geometry including acute angles structurally configured to rupture a cytoplastic material of one or more pathogens and to lipocytically destroy one or more bacteria cells;

wherein the carbon allotrope-based ink is applied to the surface by printing via one of flexography, rotogravure, and sublimation printing processes; and

wherein the printing includes a geometric pattern including lines printed with a line density based upon a predetermined grade of antipathogenic barrier.

These and other aspects of the embodiments will be better appreciated and understood when considered in conjunction with the following description and the accompanying drawings. The following description, while indicating various embodiments and details thereof, is given by way of illustration and not of limitation. Many substitutions, modifications, additions, or rearrangements may be made within the scope of the embodiments, and the embodiments may include all such substitutions, modifications, additions, or rearrangements.

### BRIEF DESCRIPTION OF THE DRAWINGS

Non-limiting and non-exhaustive embodiments of the packaging for fresh fruits and vegetables with antipathogenic barrier are described with reference to the following figures, wherein like reference numerals refer to like parts throughout the various views unless otherwise specified.

FIG. 1 is a perspective view of packaging for fresh fruits and vegetables with antipathogenic barrier, in accordance with a representative embodiment.

FIG. 2 is a perspective view of packaging for fresh fruits and vegetables with antipathogenic barrier, in accordance with a representative embodiment.

FIG. 3 illustrates an air filtering effect achieved by two or more two or more films of microperforated polymeric material, in accordance with a representative embodiment.

FIG. 4 is an enlarged cross-sectional view of packaging printed with an antipathogenic ink illustrating the effect on pathogenic microorganisms, in accordance with a representative embodiment.

FIG. 5 is a schematic view of a method of manufacturing a bottom for a container, in accordance with a representative embodiment.

FIG. 6 is a schematic view of a method of manufacturing a lid for a container, in accordance with a representative embodiment.

FIG. 7 is a perspective view of a packaging bag with antipathogenic barrier, in accordance with a representative embodiment.

FIG. 8 is a perspective view of another embodiment of a packaging container with antipathogenic barrier, in accordance with a representative embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. Also, common but well-understood elements that are useful or necessary in a commercially feasible embodiment are often not depicted in order to facilitate a less obstructed view of these various embodiments.

### DETAILED DESCRIPTION OF THE INVENTION

Packaging for fruits and vegetables with an antipathogenic barrier and manufacturing processes therefor are described herein. Embodiments include a package of cellulose and/or polymeric material in variable geometries, such as cylindrical, rectangular, and/or other forms, with low production costs, and which has an antipathogenic barrier for the reduction and/or elimination of pathogenic agents (e.g., bacteria, virus, and fungus) present in fresh fruits and vegetables, as well as in the air/environment. The packaging may include a surface finish made of a special antipathogenic ink, which may be applied to the interior of the package, as well as to the multilayer, microperforated air filters, through a printing process such as flexography, rotogravure, or sublimation. The carbon allotrope-based ink, once applied and dried at a microscopic level has two functions. The first is similar to the so-called lotus effect, i.e., self-cleaning properties due to high water repellency. This is due to the nanoscopic geometry of the printed surface. This phenomenon, also known as super-hydrophobicity or self-cleaning, is characteristically present in not only in the leaves of lotus plants, but also in other plants such as Tropaeolum, Opuntia, and Alchemilla, as well as in the wings and bodies of certain insects such as dragonfly and crawfish. This self-cleaning function prevents external adverse agents from adhering to regions printed with the ink, while helping slippage and not permanently adhering to the walls of the package.

The second function of the carbon allotrope-based ink involves the destruction of the outer cell layer of bacteria and viruses due to the nature of the characteristics of the ink. At the nanometric level, the geometric form of the carbon allotrope includes pointed edges that severely damage the external cell layers of pathogenic agents, leading to the exit of cytoplastic material and cellular death. Finally, the antipathogenic ink applied is able to interact at a nanometric level with the lipids present in the cell membrane of bacteria and viruses. Cellular destruction of pathogens starts by perforating the outer walls of their cells and converting these into a porous membrane. This cellular destruction is known as lipocytic. The double action of the ink allows, on one hand, the destruction of the cell membrane of pathogenic agents by breaking up the cell surface, and on the other hand, the cell destruction by lipocytic action. Tests utilizing the antipathogenic ink proposed herein and performed in the laboratories of SGS-CSTC Standards Technical Services (Shanghai) Co., Ltd, in China, Test Report ASH21-0078757-01 (25 Feb. 2021), after 24 hours of testing result in the following conclusions, antibacterial activity index with the following pathogens: Escherichia Coli 99.9>%, Klebsiella Pneumoniae 99.9%, Staphylococcus Aureus 99.9%, and Pseudomonas Aeruginosa 99.9%. Antibacterial activity is not limited to these four pathogens and can be magnified as more antibacterial tests are performed. The effectiveness of the spectrum of antibacterial activity will depend on the concentration of carbon allotrope present, as well as on the density of the patterns of the geometries printed on the package.

In some embodiments, the packaging includes specific areas which are hollow and covered with a membrane of two or more layers, including films of polymeric material with microperforations printed with a carbon allotrope-based ink with antipathogenic properties. These overlaid film layers have an air-filtering function, where the air that flows from outside in, and vice versa, follows a long, tortuous path. By circulating air through the layers, microparticles of pathogenic agents are trapped. Bacteria, viruses, fungi, or the like that contact the antipathogenic ink, will be eliminated as explained above, by cell destruction and/or super-hydrophobicity action. Antipathogenic ink finishes are applied, utilizing variable line-density geometric patterns, depending upon the degree of antipathogenic protection that is desired to be given. The greater the number of lines in the geometric pattern, the greater the ability to remove the pathogenic agents.

The manufacturing process for a portion of a container (such as the bottom of a rigid or semi-rigid package made from cellulose such as paperboard, and/or a rigid or semi-rigid lid made from cellulose) is accomplished by a swaging process of a cellulose paperboard strip, in this case in a rectangular shape, which successively is bonded to two or more layers of microperforated polymeric material (e.g., a microperforated film), wherein the bond is performed using adhesive applied only at the edges of the swaged area. Importantly, only the edges of the film layers are adhered - the layers are not laminated together. This configuration allows air to flow from slowly, but continuously, between the inside and outside of the container through the polymer film layers.

Another embodiment of the base of the package includes a bottom made of cellulose paperboard with perforations to ensure venting. The bottom has a geometric pattern of antipathogenic ink printed on its surface. This solution may be recommended to reduce costs and manufacturing times as compared with other embodiments.

Another embodiment of the packaging includes a flexible bag made of polymeric material, which may be formed from two or more film layers, with limited microperforated zones. The main body of the bag is laminated through the application of adhesive, while the edges of the microperforated zones are glued and not laminated, enabling air flow in both directions. An antipathogenic ink finish is applied to the microperforated zone between the polymeric material layers, as well as in specific areas on the interior of the bag.

FIG. 1 is a perspective view of an embodiment of packaging for fresh fruits and vegetables with antipathogenic barrier. The package 1 and 2 may be made of rigid or semi-rigid cellulosic material, such as paperboard. The package may have a lid 3, which may also be made of rigid or semi-rigid cellulosic material. The lid 3 may include with a hollow window 4 in an upper part of the lid. The package may also have a bottom 5with a hollow window. Both windows may be coated with two or more films of microperforated polymeric material 6 (such as biopolymer films). The films of microperforated polymeric material may be attached (e.g., by an adhesive) only at the edges 7, 8 of the hollow window 4. An internal wall 10 of the package includes a geometric pattern 9 of printed lines of a carbon allotrope-based ink. The ink may be applied using an industrial printing process such as flexography, rotogravure, and/or sublimation. The geometry and density of printed line patterns may be adjusted based upon the degree of protection desired to be given. A higher line density of the printed line pattern 10 imparts a higher antipathogenic level.

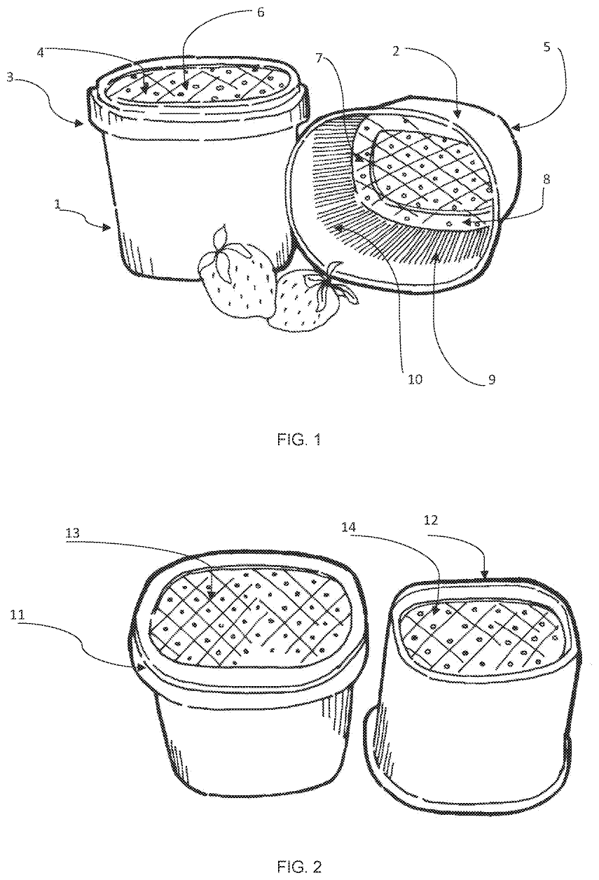

FIG. 2 is a perspective view of an embodiment of packaging for fresh fruits and vegetables with antipathogenic barrier. The package includes a lid 11 having a hollow window 13 and a bottom 12 with a hollow window 14. Both hollow windows are covered with two or more layers or films of microperforated polymeric material printed with antipathogenic ink., wherein the printing is represented with diagonal lines. Geometric patterns may be printed on the inside of each layer, thus, the passage of air through the microperforations of the films deposits pathogenic microorganisms between the layers that are destroyed upon contact with the printed lines, due to the antipathogenic properties of the ink.

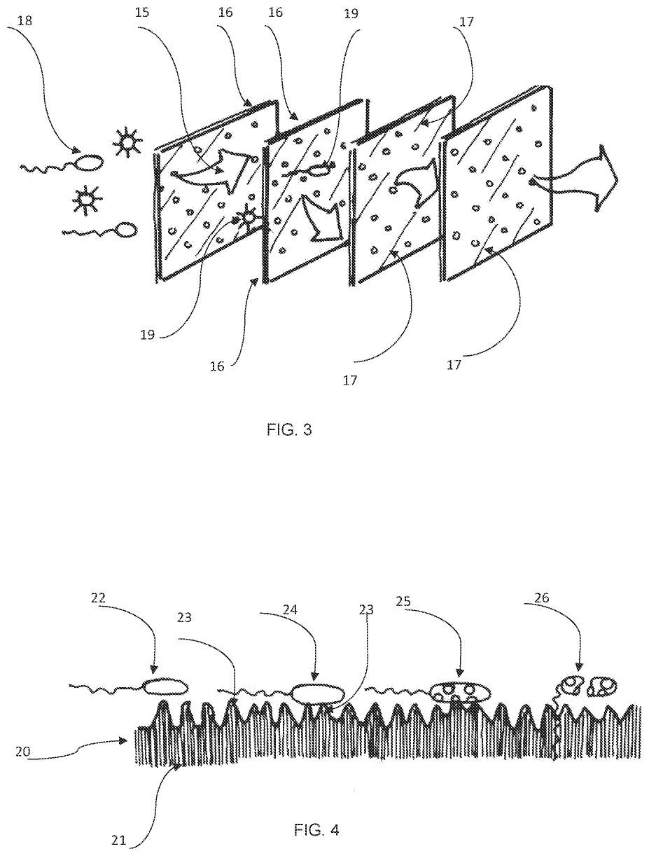

FIG. 3 illustrates the air filtering effect 15 achieved by the overlaying of two or more layers of microperforated film 16. From left to right the passage of air is shown from the outside the package to the inside thereof. Due to the microperforation of films of polymeric material and to the printing of geometric patterns of antipathogenic ink 17, filtering is accomplished and removal of the adverse agents 18 present in the air 19 is also achieved.

FIG. 4 is an enlarged cross-sectional view of packaging printed with an antipathogenic ink illustrating the effect on pathogenic microorganisms. The illustration is a graphical representation, enlarged about 50,000 times, showing antipathogenic ink features 20. A cross-section of the antipathogenic ink printed line pattern 21 can be seen running from left to right. A bacterium 22 which may move over the printed surface, may be sized on the order of 50 um. The surface of the ink, at the nanometric level, has acute angles 23 which enter into contact with the cellular layer of pathogenic agents 24 puncturing their cell layer 25 in part due to the acute geometry of the surface, in part due to the lipocytic action, and, subsequently, output of the cytoplastic material and the destruction of the pathogen 26 results.

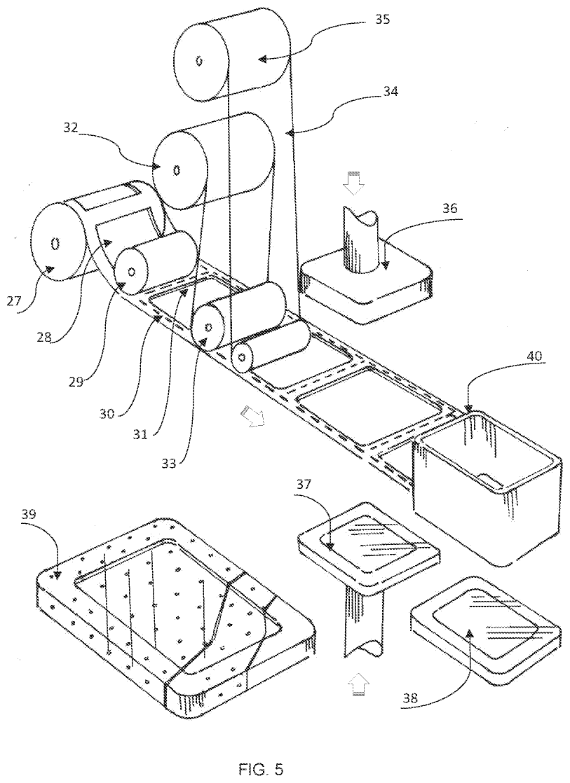

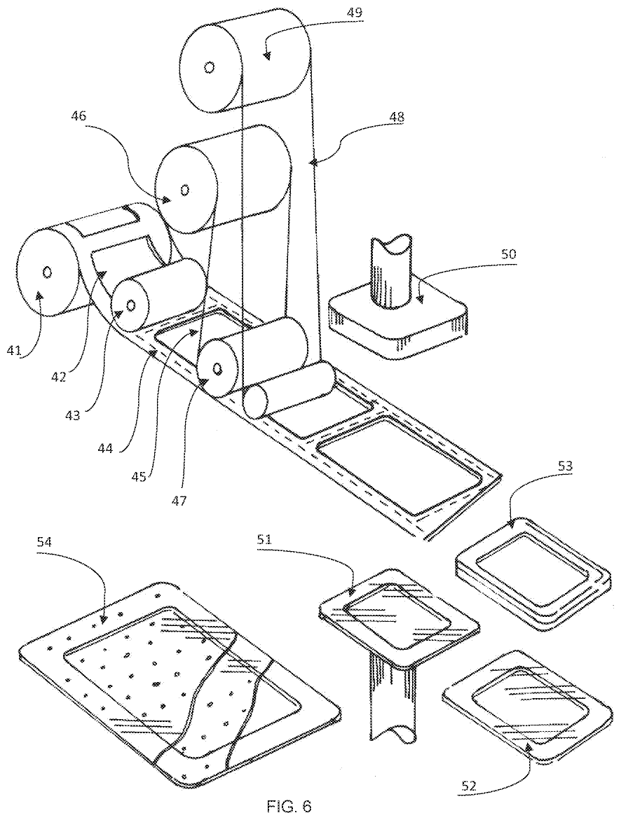

FIG. 5 is a perspective view showing schematically a method of manufacturing and assembling a bottom for rigid containers manufactured with semi-rigid cellulose sheets. The process, as represented from left to right, includes: a roll 27 in the form of a tape or strip of semi-rigid cellulosic material with rectangular perforations previously achieved through a swaging process to form a hollow swaged area 28; the cellulose tape is then made adherent through a cylinder 29 that applies a first layer 30 (e.g., adhesive lines) over the surface of the tape; wherein first adhesive layer 30 will subsequently serve to adhere the first film of microperforated polymeric material 31 contained in a roll 32 of the same material that has previously been printed with a geometry utilizing carbon allotrope-based ink. A second gluing cylinder 33 applies a second adhesive layer that serves to adhere the second film of microperforated polymeric material 34 contained in a roll 35 of the same material. The cellulose tape with the two films adhered to its surface is subsequently swaged and formed under pressure, for example by a concave punch 36 and a complementary shaped convex punch 37, whereby the cellulose tape and its two layers of microperforated polymeric film forms a three-dimensional bottom 38. Bottom 38 may later be adhered to a semi-rigid paperboard container body 40. A detail view 39 of the bottom is shown including three components: the cellulose base and two layers of microperforated film. Finally, the container body 40 may have base 38 attached to its bottom.

FIG. 6 is a schematic view of a method of manufacturing a lid for a container made from semi-rigid cellulose sheets 41, where the process is illustrated from left to right. A roll in the form of semi-rigid cellulose tape includes rectangular perforations made previously through swaging 42; the cellulose tape is subsequently made adherent through a cylinder 43 that applies lines of adhesive 44 on the surface of the tape, which will later serve to adhere the first film of microperforated polymeric material 45 that has been previously printed with a geometry utilizing antipathogenic ink and contained in a roll of the same material 46. A second gluing cylinder 47 applies a second adhesive layer (e.g., lines of adhesive) that will serve to adhere the second film of microperforated polymeric material 48 contained in a roll of the same material 49. The cellulose tape with the two films adhered to its surface is subsequently swaged, by an upper swage 50 and a bottom swage 51 where the cellulose tape and its two layers of microperforated polymeric film is formed 52, to be subsequently attached to the bottom of the lid and semi-rigid paperboard threading 53. A detail view 54 of the lid illustrates and its three components: the cellulosic material and two layers of microperforated film.

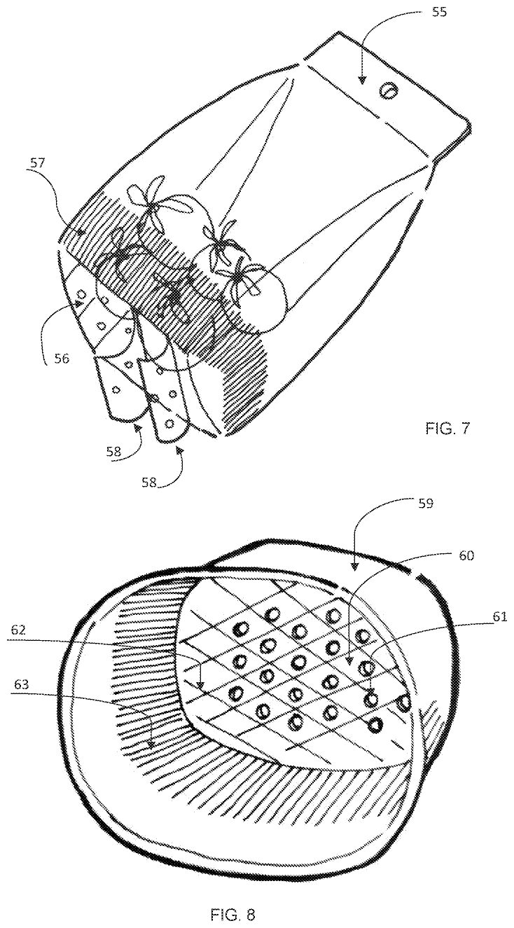

FIG. 7 is a perspective view of a packaging bag with antipathogenic barrier. The bag 55 may be made of flexible polymeric material, including a laminated body with two or more layers of polymeric material 56, and where an internal area of bag 55 is printed with geometric patterns with carbon allotrope-based ink 57. In addition, to an area forming a membrane may be composed of two or more microperforated films glued at their edges 58, but not laminated, and printed with antipathogenic ink following a geometrical pattern based on the level of antipathogenic protection desired to be obtained.

FIG. 8 is a perspective view of another embodiment of a packaging container with antipathogenic barrier. The package 59 is made of rigid cellulose material, which has a rigid bottom 60 in cellulose material such as paperboard, with numerous perforations 61 that allow air venting between the inside and outside of the package. This solution decreases production costs as compared to other manufacturing methods discussed herein. A printed line pattern 63 utilizing a graphene-based ink 62 may be printed on the container using an industrial printing process such as flexography, rotogravure, and/or sublimation. The geometry and density of printed line patterns 63 will depend upon the degree of protection desired to be given. A higher line density within printed line pattern 63 will produce a higher antipathogenic level.

The embodiments of the packaging with antipathogenic barrier and manufacturing methods described herein are exemplary and numerous modifications, combinations, variations, and rearrangements can be readily envisioned to achieve an equivalent result, all of which are intended to be embraced within the scope of the appended claims. Further, nothing in the above-provided discussions of the packaging and methods should be construed as limiting the invention to a particular embodiment or combination of embodiments. The scope of the invention is defined by the appended claims.

1. A package for fruits and vegetables, the package having an antipathogenic barrier, the package comprising:
a container formed from a strip of semi-rigid material folded onto itself, the container having one or more internal walls;
a geometric pattern comprising a carbon allotrope-based ink printed on at least one of the one or more internal walls; and
wherein the geometric pattern includes lines printed with a line density based upon a predetermined grade of antipathogenic barrier.

2. The package of claim 1, wherein:
the container includes a bottom having a hollow window;
the hollow window is covered by a membrane including two or more films of microperforated polymeric material; and
the geometric pattern comprising a carbon allotrope-based ink is printed on the two or more films such that the membrane provides an antipathogenic barrier.

3. The package of claim 1, wherein:
the container includes a bottom formed of a cellulosic material having a plurality of perforations substantially homogeneously distributed on a surface of the bottom; and
the geometric pattern comprising a carbon allotrope-based ink is printed on the two or more films such that the membrane provides an antipathogenic barrier.

4. The package of claim 1, further including:
a lid structurally configured to cover the container, the lid having a hollow window covered by a membrane including two or more films of microperforated polymeric material; and
the geometric pattern comprising a carbon allotrope-based ink printed on the two or more films such that the membrane provides an antipathogenic barrier.

5. The package of claim 4, wherein:
the lid is formed of at least one of a semi-rigid cellulose material and a rigid polymeric material.

6. The package of claim 1, wherein:
the geometric pattern is printed via one of flexography, rotogravure, and sublimation printing processes.

7. A package for fruits and vegetables, the package having an antipathogenic barrier, the package comprising:
a bag having a laminated body including two or more layers of flexible polymeric material and one or more internal walls;
a geometric pattern comprising a carbon allotrope-based ink printed on at least one of the one or more internal walls;
at least a portion of the bag including two or more microperforated polymeric film layers including the geometric pattern printed thereon; and
wherein the two or more microperforated polymeric film layers are attached to one another only along one or more edges thereof.

8. A finish for a surface, the finish having antipathogenic properties, the finish comprising:
a carbon allotrope-based ink having a nanometric geometry including acute angles structurally configured to rupture a cytoplastic material of one or more pathogens and to lipocytically destroy one or more bacteria cells;
wherein the carbon allotrope-based ink is applied to the surface by printing via one of flexography, rotogravure, and sublimation printing processes; and
wherein the printing includes a geometric pattern including lines printed with a line density based upon a predetermined grade of antipathogenic barrier.

9. A method of manufacturing a portion of a container having antipathogenic properties, the method comprising:
swaging a strip of semi-rigid cellulosic material with perforations to form a hollow swaged area;
applying a first adhesive layer to the strip of semi-rigid cellulosic material in localized areas proximate edges of the hollow swaged area;
printing one side of each of a first film of microperforated polymeric material and a second film of microperforated polymeric material with a carbon allotrope-based ink;
laying the first film of microperforated polymeric material over the hollow swaged area, the first film of microperforated polymeric material covering the entire hollow swaged area;
applying pressure so that the first film of microperforated polymeric material is adhered to the strip of semi-rigid cellulosic material by the first adhesive layer;
applying a second adhesive layer to the first film of microperforated polymeric material in localized areas proximate edges of the hollow swaged area;
laying the second film of microperforated polymeric material over the hollow swaged area, the second film of microperforated polymeric material covering the entire hollow swaged area; and
applying pressure so that the second film of microperforated polymeric material is adhered to the first film of microperforated polymeric material by the second adhesive layer, so that the first film of microperforated polymeric material is adhered to the second film of microperforated polymeric material only along one or more edges thereof, thereby creating a tortuous pathway for air through the first film of microperforated polymeric material and the second film of microperforated polymeric material.

10. The method of claim 9, further comprising:
shaping, using a concave punch and a complementary convex punch, the strip of semi-rigid cellulosic material to form a three-dimensional bottom for the container; and
joining the three-dimensional bottom, using at least one of adhesive and heat, to a container body to form the container having antipathogenic properties.

11. The method of claim 9, further comprising:
swaging the strip of semi-rigid cellulosic material with the first film of microperforated polymeric material and the second film of microperforated polymeric material adhered thereto to form a portion of a lid; and
joining the portion of the lid, using at least one of adhesive and heat, to a lid body to form a lid for having antipathogenic properties the container.

12. The method of claim 11, wherein:
the lid body is formed of semi-rigid cellulosic material and includes threading.

13. The method of claim 9, wherein:
the first adhesive layer and the second adhesive layer are applied via a flexographic process.
